(19) United States
(12) Patent Application Publication
(10) Pub. No.: US 2020/0377647 A1
(43) Pub. Date: Dec. 3, 2020

(54) RESIN COMPOSITION, RESIN SHEET, CURED RESIN PRODUCT, RESIN SUBSTRATE, AND LAMINATE SUBSTRATE

(71) Applicant: TDK CORPORATION, Tokyo (JP)

(72) Inventors: Keiji ENOMOTO, Tokyo (JP); Masaaki YAMASHITA, Tokyo (JP); Hiroshi SHUTOH, Tokyo (JP); Tsuyoshi SUGIYAMA, Tokyo (JP); Tomoyuki HARAI, Tokyo (JP); Yutaka SHIMIZU, Tokyo (JP)

(73) Assignee: TDK CORPORATION, Tokyo (JP)

(21) Appl. No.: 16/496,816

(22) PCT Filed: Mar. 13, 2018
(86) PCT No.: PCT/JP2018/009788

§ 371 Date: Sep. 23, 2019

(30) Foreign Application Priority Data
Mar. 31, 2017 (JP) 2017-070032
Mar. 31, 2017 (JP) 2017-071088

(51) Int. Cl. C08G 59/40; C08L 63/10; C08K 3/38; C08K 5/5313; C08K 5/13; C08K 5/18; C08J 5/18; B32B 27/38; B32B 27/26

(52) U.S. Cl. CPC C08G 59/4071; C08L 63/10; C08K 3/38; C08K 5/5313; C08K 2003/385; C08K 5/18; C08J 5/18; B32B 27/38; B32B 27/26; C08K 5/13

(57) ABSTRACT

A resin composition including a main agent containing an epoxy compound, a curing agent, and inorganic particles, the curing agent includes an aromatic compound in which a ratio of the number of carbon atoms constituting an aromatic ring to a total number of carbon atoms in one molecule is 85% or more, a content of the inorganic particles is 40 to 75 vol % based on a total amount of components other than a solvent, the inorganic particles include boron nitride particles and particles different from the boron nitride particles, and a content of the boron nitride particles is 3 to 35 vol % based on a total amount of components other than a solvent.

### TECHNICAL FIELD

The present disclosure relates to a resin composition, a resin sheet, a cured resin product, a resin substrate, and a laminate substrate.

According to power conversion of automobiles, high integration of semiconductors, and proliferation of LED lightings, it is required for organic insulating materials used for adhesives, casting materials, sealing materials, molding materials, laminate substrates, composite substrates and the like to have an excellent heat dissipation property. In order to improve a heat dissipation property of organic insulating materials, it is effective to increase the thermal conductivity. Regarding organic insulating materials having high thermal conductivity, cured products of a resin composition containing an epoxy compound having a biphenyl framework are known.

In the resin composition described above, addition of an inorganic filler such as magnesium oxide has been attempted in order to improve a heat dissipation property. For example, Patent Literature 1 proposes a resin composition for a printed circuit board including a thermosetting resin and an inorganic filler having a predetermined volume average particle size and particle size distribution and a prepreg using the resin composition. In the above prepreg and resin composition, addition of a phosphorus compound together with the inorganic filler has been attempted in order to improve flame retardance. Patent Literature 2 proposes addition of a curing agent containing aluminum hydroxide and phosphorus.

### BACKGROUND Art

### Citation List

### Patent Literature

### Patent Literature 1

Japanese Unexamined Patent Application, First Publication No. 2016-3260

### Patent Literature 2

Japanese Unexamined Patent Application, First Publication No. 2012-12591

### SUMMARY OF INVENTION

### Technical Problem

A resin composition is used for various applications such as an adhesive, a resin sheet, and a laminate substrate. For example, when a resin substrate having a glass cloth and a laminate substrate having an inner layer circuit are formed, it is necessary to quickly fill a resin composition used for a resin sheet serving as a prepreg for a printed board into gaps of the glass cloth and recesses of the inner layer circuit. Therefore, it is necessary for the resin composition to have excellent filling properties. In addition, a cured resin product is used as an organic insulating material, but when it is used under a high temperature environment, a carbonized conduction path is formed due to repetition of fine discharging on the surface of the cured product, and a tracking phenomenon causing insulation breakdown may occur. In addition, similarly, when a resin substrate having a glass cloth and a laminate substrate having an inner layer circuit are formed, it is necessary to have a heat dissipation property and flame retardance. While addition of an inorganic filler is effective to improve such characteristics, inorganic fillers are likely to sediment because they have a higher specific gravity than other components in the resin composition. Therefore, due to non-uniformity of the dispersion, there is concern of the quality of the resin composition and the cured product varying.

Therefore, in one aspect of the present invention, an object is to provide a resin composition and resin sheet which can form a cured resin product, resin substrate, and laminate substrate which have an excellent heat dissipation property and tracking resistance, and have an excellent filling property. In another aspect of the present invention, an object is to provide a cured resin product, a resin substrate, and a laminate substrate which have an excellent heat dissipation property and tracking resistance by using the resin composition or the resin sheet. In addition, in one aspect of the present invention, an object is to provide a resin composition and resin sheet which can form a cured resin product, resin substrate, and laminate substrate having an excellent heat dissipation property and flame retardance, and has excellent dispersibility. In another aspect of the present invention, an object is to provide a cured resin product, resin substrate, and laminate substrate which have an excellent heat dissipation property and flame retardance by using the resin composition or the resin sheet.

### Solution to Problem

In one aspect of the present invention, there is provided a resin composition including a main agent containing an epoxy compound, a curing agent, and inorganic particles, wherein the curing agent includes an aromatic compound in which a ratio of the number of carbon atoms constituting an aromatic ring to a total number of carbon atoms in one molecule is 85% or more, a content of the inorganic particles is 40 to 75 vol % based on a total amount of components other than a solvent, the inorganic particles include boron nitride particles and particles other than boron nitride particles, and the content of boron nitride particles is 3 to 35 vol % based on a total amount of components other than a solvent.

The resin composition includes a curing agent containing an aromatic compound in which a ratio of the number of carbon atoms constituting an aromatic ring to a total number of carbon atoms in one molecule is 85% or more. In the resin composition containing such a curing agent, aromatic rings easily overlap according to the π-π stacking, and scattering of molecular lattice vibration is unlikely to occur. Therefore, a cured product of such a resin composition has high thermal conductivity.

Here, since the aromatic rings contained in the aromatic compound tend to be easily carbonized, there is concern of tracking resistance being impaired. However, the resin composition includes a predetermined amount of boron nitride particles as inorganic particles. It is thought that the π-electrons of boron nitride have an effect of improving a heat dissipation property between boron nitride particles and the aromatic compound and an effect of stabilizing the structure of the aromatic ring according to the interaction (π-π stacking) with π-electrons of the aromatic rings contained in the aromatic compound. It is thought that stabilizing of the structure of the aromatic ring contributes to reducing carbonization and improving tracking resistance.

Here, when the proportion of boron nitride particles in the resin composition is excessive, there is concern of the viscosity of the resin composition increasing and a filling property being impaired. Therefore, when the resin composition of the present invention includes inorganic particles different from boron nitride particles as inorganic particles, it is possible to adjust the viscosity of the resin composition while maintaining an excellent heat dissipation property and tracking resistance. That is, when boron nitride particles and inorganic particles different from boron nitride particles are contained, it is possible to obtain high levels of all characteristics such as a filling property of the resin composition, and a heat dissipation property and tracking resistance of the cured product. According to the above effects, it is thought that it is possible to provide a resin composition which can form a cured resin product, resin substrate, and laminate substrate which have an excellent filling property and an excellent heat dissipation property and tracking resistance. However, the mechanism of action of improvement in a filling property, a heat dissipation property, and tracking resistance is not limited to that described above.

Aromatic compounds contained in the curing agent preferably include a polycyclic aromatic compound having 4 to 6 benzene rings in one molecule. Accordingly, it is possible to further improve thermal conductivity while the increase in viscosity of the resin composition is reduced. Therefore, a resin composition having a better heat dissipation property and filling property can be obtained.

The aromatic compounds contained in the curing agent may include a triphenylbenzene compound represented by the following General Formula (1). Accordingly, it is possible to obtain higher levels of three characteristics including a heat dissipation property, a filling property, and tracking resistance. In the following General Formula (1), R₁ to R₁₅ each independently represents a hydrogen atom, a hydroxyl group, an amino group or a carboxyl group, and at least one of R₁ to R15 represents a hydroxyl group, an amino group or a carboxyl group:

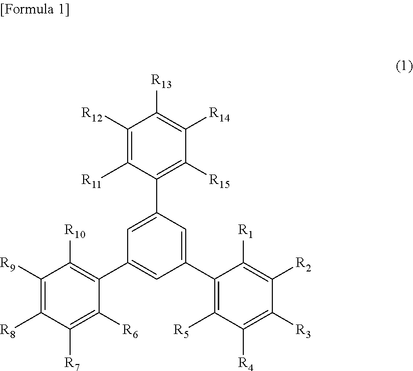

Preferably, the aromatic compounds contained in the curing agent include a phosphorus compound. Accordingly, it is possible to improve flame retardance of the resin composition and further improve the tracking resistance.

Preferably, the aromatic compounds include a phosphorus compound represented by the following General Formula (2), (3) or (4). Accordingly, it is possible to improve flame retardance of the resin composition and further improve the tracking resistance:

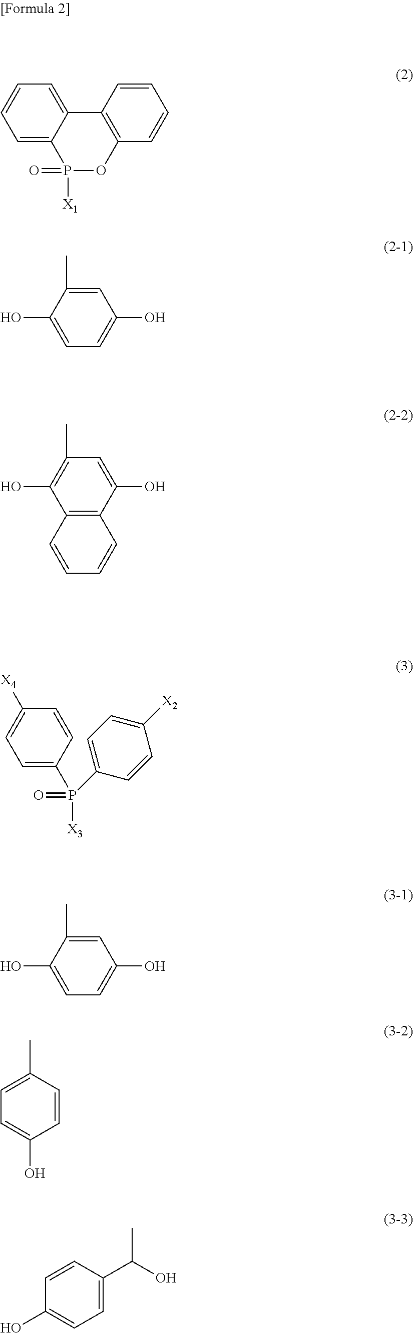

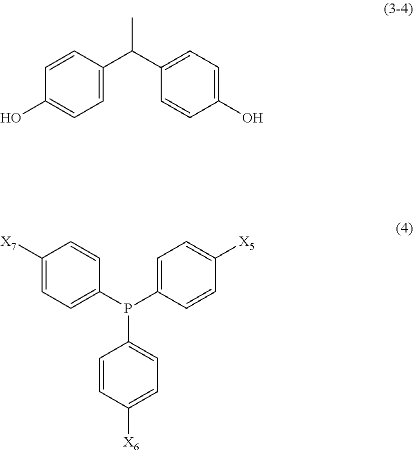

### [In General Formula (2), X₁ is Formula (2-1) or (2-2).]

[In General Formula (3), X₂ and X₄ each independently represents a hydrogen atom or a hydroxyl group, and X₃ represents a hydrogen atom, a hydroxyl group, a phenyl group, or any of Formulae (3-1) to (3-4).]
[In General Formula (4), X₅ to X₇ each independently represents a hydrogen atom or a hydroxyl group, and at least one of X₅ to X₇ represents a hydroxyl group.]

In another aspect of the present invention, there is provided a resin sheet obtained by molding the resin composition. The resin sheet can form a cured resin product, resin substrate, and laminate substrate which have an excellent filling property, and an excellent heat dissipation property and tracking resistance.

In still another aspect of the present invention, there is provided a cured resin product including a cured product of the resin composition. Since the cured resin product includes a cured product of the resin composition, it has an excellent heat dissipation property and tracking resistance.

In still another aspect of the present invention, there is provided a resin substrate including a cured product of the resin composition. Since the resin substrate includes a cured product of the resin composition, it has an excellent heat dissipation property and tracking resistance.

In still another aspect of the present invention, there is provided a laminate substrate, a plurality of resin substrates being laminated therein, wherein at least one of the plurality of resin substrates includes a cured product of the resin composition. Since the laminate substrate includes a resin substrate including a cured product of the resin composition, it has an excellent heat dissipation property and tracking resistance.

In one aspect of the present invention, there is provided a resin composition including an epoxy compound, a curing agent, and inorganic particles, wherein the curing agent includes at least one phosphorus compound of the following General Formula (9) and General Formula (10); and an aromatic compound represented by the following General Formula (11), and a content of the phosphorus compound with respect to a total of 100 parts by mass of organic components other than a solvent is 8 parts by mass or more:

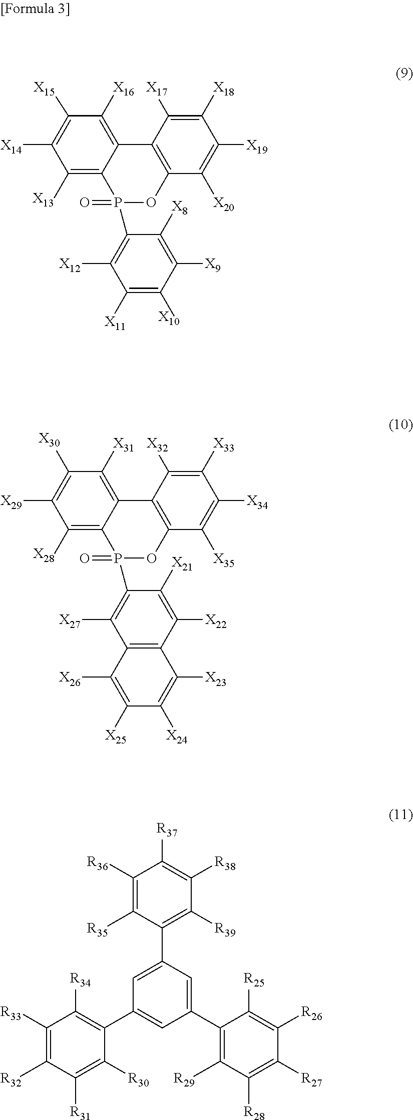

[In General Formula (9), X₈ to X₂₀ each independently represents a hydrogen atom, an alkyl group or a hydroxy group, and at least one of X₈ to X₁₂ represents a hydroxy group.]
[In General Formula (10), X₂₁ to X₃₅ each independently represents a hydrogen atom, an alkyl group or a hydroxy group, and at least one of X₂₁ to X₂₇ represents a hydroxy group.]
[In General Formula (11), R₂₅ to R₃₉ each independently represents a hydrogen atom, a hydroxyl group, or an amino group, and at least one of R25 to R₃₉ represents a hydroxyl group or an amino group.]

Since the resin composition includes a predetermined amount of at least one phosphorus compound of General Formula (9) and General Formula (10), it has excellent flame retardance. In addition, in the aromatic compound represented by General Formula (11), benzene rings easily overlap according to the π-π stacking, and an interval between benzene rings can be reduced. Therefore, the density of the cured product can increase, and the thermal conductivity can be improved. In addition, it is thought that reduction of scattering of molecular lattice vibration also contributes to improving thermal conductivity. Therefore, the cured product of the resin composition containing the aromatic compound has high thermal conductivity and an excellent heat dissipation property.

In addition, the phosphorus compound is poorly soluble in the solvent and is contained in a solid content in the resin composition. Therefore, it is possible to reduce sedimentation of inorganic particles contained in the resin composition. Therefore, it is possible to improve dispersibility of the resin composition and improve the uniformity of a resin sheet and cured product obtained by molding the resin composition.

In the resin composition, the content of the elemental phosphorus may be 0.8 parts by mass or more with respect to a total of 100 parts by mass of the organic components. When elemental phosphorus is contained in such a range, it is possible to form a cured product having better flame retardance.

In the resin composition, the content of the phosphorus compound with respect to a total of 100 parts by mass of the organic components may be 8 to 20 parts by mass. Accordingly, it is possible to obtain sufficiently high levels of both flame retardance and a heat dissipation property.

Preferably, the aromatic compounds include at least one of 1,3,5-tris(4-hydroxyphenyl)benzene and 1,3,5-tris(4-aminophenyl)benzene, and a total content of 1,3,5-tris(4-hydroxyphenyl)benzene and 1,3,5-tris(4-aminophenyl)benzene with respect to a total amount of the curing agent is 15 mass % or more. Accordingly, it is possible to further improve the thermal conductivity and form a cured product having a better heat dissipation property.

In another aspect of the present invention, there is provided a resin sheet obtained by molding the resin composition. Since the resin sheet is obtained by molding a resin composition having excellent dispersibility, it has excellent uniformity. In addition, it is possible to form a cured resin product, resin substrate and laminate substrate having an excellent heat dissipation property and flame retardance.

In still another aspect of the present invention, there is provided a cured resin product including a cured product of the resin composition. Since the cured resin product includes a cured product of the resin composition, it has an excellent heat dissipation property and flame retardance.

In still another aspect of the present invention, there is provided a resin substrate including a cured product of the resin composition. Since the resin substrate includes a cured product of the resin composition, it has an excellent heat dissipation property and flame retardance.

In still another aspect of the present invention, there is provided a laminate substrate in which a plurality of resin substrates are laminated, and at least one of the plurality of resin substrates includes a cured product of the resin composition. Since the laminate substrate includes a resin substrate including a cured product of the resin composition, it has an excellent heat dissipation property and flame retardance.

### Advantageous Effects of Invention

In one aspect of the present invention, it is possible to provide a resin composition and resin sheet which can form a cured resin product, resin substrate and laminate substrate which have an excellent heat dissipation property and tracking resistance, and have an excellent filling property. In another aspect of the present invention, it is possible to provide a cured resin product, resin substrate and laminate substrate which have an excellent heat dissipation property and tracking resistance by using the resin composition or resin sheet. In addition, in one aspect of the present invention, it is possible to provide a resin composition having excellent dispersibility and a resin sheet having excellent uniformity which can form a cured resin product, resin substrate and laminate substrate having an excellent heat dissipation property and flame retardance. In another aspect of the present invention, it is possible to provide a cured resin product, resin substrate, and laminate substrate which have an excellent heat dissipation property and flame retardance by using the resin composition or the resin sheet.

### BRIEF DESCRIPTION OF DRAWINGS

FIG. 1 is a perspective view of a resin sheet and a resin substrate.

FIG. 2 is a cross-sectional view of the resin sheet and the resin substrate taken along the line II-II in FIG. 1.

FIG. 3 is a perspective view of a laminate substrate.

FIG. 4 is a cross-sectional view of the laminate substrate taken along the line IV-IV in FIG. 3.

FIG. 5 is a graph showing the change in viscosity of Example 1.

### DESCRIPTION OF EMBODIMENTS

### First Embodiment

A first embodiment according to claims 1 to 4, and 10 to 13 of the present invention will be described below with reference to the drawings in some cases. However, the following embodiment is only an example for describing the present invention, and the present invention is not limited to the following content. In the description, components which are the same or components having the same functions are denoted with the same reference numerals and redundant descriptions will be omitted in some cases. In addition, positional relationships such as above, below, left and right are based on the positional relationship shown in the drawings unless otherwise specified. In addition, the dimensional ratios of respective components are not limited to the illustrated ratios.

A resin composition of the present embodiment includes a main agent containing an epoxy compound, a curing agent, and inorganic particles. Here, the main agent is a component which is polymerized by a curing agent and forms a cured product together with the curing agent. Examples of the epoxy compound include glycidyl ethers, glycidyl esters, and glycidyl amines. Among these, one epoxy compound may be used alone or a plurality of epoxy compounds may be used in combination. In order to obtain higher thermal conductivity, the epoxy compound preferably has a mesogen framework in which two or more benzene rings are included such as a biphenyl framework or a terphenyl framework in the molecule. When such an epoxy compound is included, it is possible to improve the stackability of benzene rings together with aromatic compounds contained in the curing agent. When the stackability of benzene rings is improved, it is possible to further reduce scattering of phonons, which causes reduction in thermal conductivity, in the cured product. Accordingly, it is possible to further improve the thermal conductivity and further improve a heat dissipation property.

Epoxy compounds preferably include glycidyl ethers having a biphenyl framework and two or more epoxy groups in one molecule (for example, those having a biphenyl framework such as biphenyl glycidyl ether and tetramethyl biphenyl glycidyl ether), and glycidyl ethers having a mesogen framework such as a terphenyl framework.

The curing agent includes an aromatic compound in which a ratio of the number of carbon atoms constituting an aromatic ring to a total number of carbon atoms in one molecule is 85% or more. According to a curing agent containing such an aromatic compound, aromatic rings easily overlap according to the π-π stacking, and it is possible to reduce scattering of molecular lattice vibration. Therefore, the cured product of such a resin composition is thought to have high thermal conductivity. In order to further improve the thermal conductivity, a ratio of the number of carbon atoms constituting an aromatic ring to a total number of carbon atoms in one molecule is preferably 86% or more and more preferably 90% or more.

The aromatic compounds contained in the curing agent preferably include a polycyclic aromatic compound having 4 to 6 benzene rings in one molecule. Accordingly, it is possible to further improve thermal conductivity while the increase in viscosity of the resin composition is reduced. Therefore, the resin composition can have a better heat dissipation property and filling property.

The aromatic compounds contained in the curing agent may include a triphenylbenzene compound represented by the following General Formula (1). Accordingly, it is possible to obtain high levels of three characteristics including a heat dissipation property, a filling property, and tracking resistance. In the following General Formula (1), R₁ to R₁₅ each independently represents a hydrogen atom, a hydroxyl group, an amino group or a carboxyl group, and at least one of R₁ to R₁₅ represents a hydroxyl group, an amino group or a carboxyl group. That is, the triphenylbenzene compound represented by General Formula (1) is a derivative of 1,3,5-triphenylbenzene.

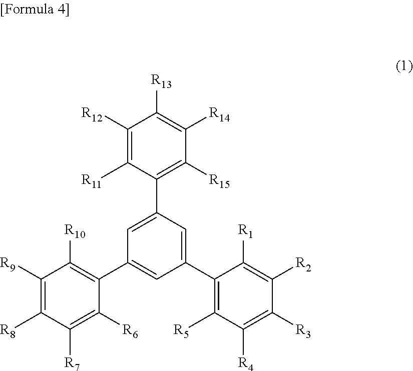

The aromatic compounds contained in the curing agent preferably include a phosphorus compound. Accordingly, it is possible to further improve flame retardance of the resin composition. Therefore, the resin composition can have better tracking resistance.

The aromatic compounds contained in the curing agent preferably include a phosphorus compound represented by any of the following General Formulae (2) to (4). Accordingly, it is possible to further improve flame retardance of the resin composition. Therefore, the resin composition can have better tracking resistance.

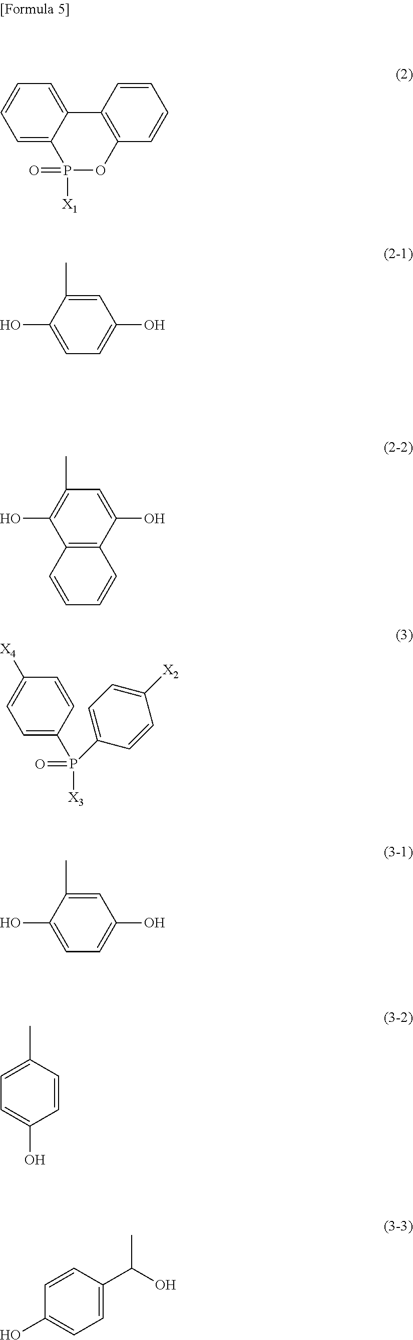

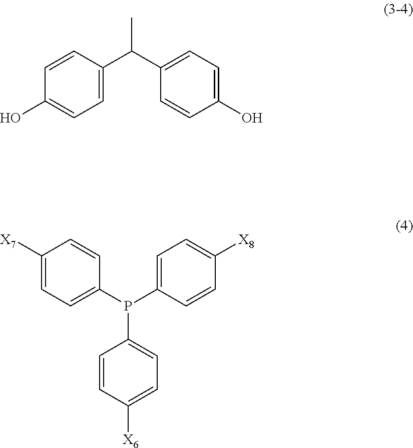

### [In General Formula (2), X₁ is Formula (2-1) or (2-2).]

[In General Formula (3), X₂ and X₄ each independently represents a hydrogen atom or a hydroxyl group, and X₃ represents a hydrogen atom, a hydroxyl group, a phenyl group, or any of Formulae (3-1) to (3-4).]
[In General Formula (4), X₅ to X₇ each independently represents a hydrogen atom or a hydroxyl group, and at least one of X₅ to X₇ represents a hydroxyl group.]

Examples of triphenylbenzene compounds include 1,3,5-tris(4-aminophenyl)benzene, and 1,3,5-tris(4-hydroxyphenyl)benzene. In 1,3,5-tris(4-aminophenyl)benzene, respective active hydrogen atoms of three amino groups in one molecule can react with epoxy groups in the epoxy compound. Accordingly, in the cured product, a strong resin structure having a high crosslinking density is formed. Therefore, it is possible to further improve a heat dissipation property and flame retardance.

Also in 1,3,5-tris(4-hydroxyphenyl)benzene having the same main framework as in 1,3,5-tris(4-aminophenyl)benzene, respective active hydrogen atoms of three hydroxyl groups in one molecule can react with epoxy groups in the epoxy compound. Accordingly, in the cured product, a strong resin structure having a high crosslinking density is formed. Therefore, it is possible to further improve a heat dissipation property and flame retardance.

The aromatic compounds contained in the curing agent may include at least one selected from among the following General Formulae (5) to (8).

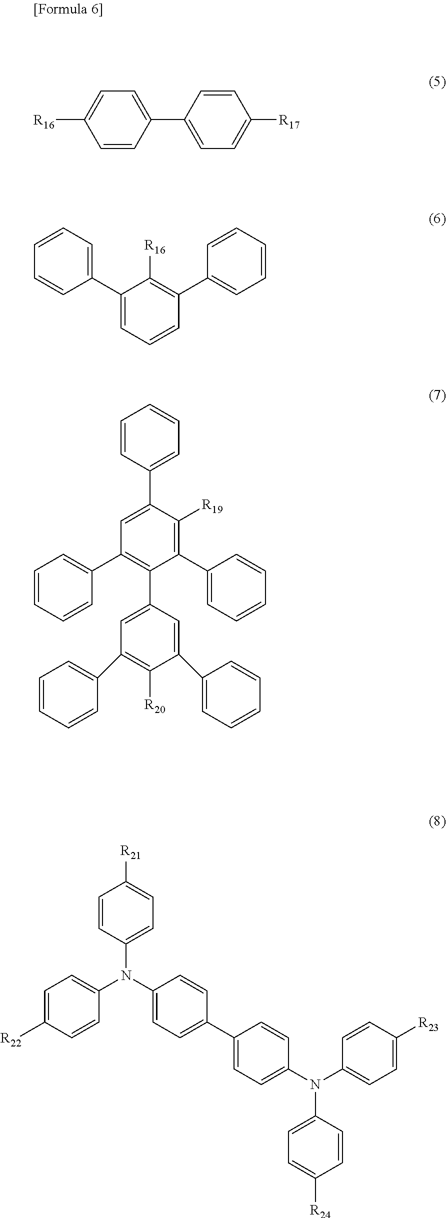

[In General Formula (5), R₁₆ and R₁₇ each independently represents a hydrogen atom, a hydroxyl group, an amino group or a carboxyl group, and at least one of R₁₆ and R₁₇ represents a hydroxyl group, an amino group or a carboxyl group.]
[In General Formula (6), R₁₈ represents a hydroxyl group, an amino group or a carboxyl group.]
[In General Formula (7), R₁₉ and R₂₀ each independently represents a hydrogen atom, a hydroxyl group, an amino group or a carboxyl group, and at least one of R₁₉ and R₂₀ represents a hydroxyl group, an amino group or a carboxyl group.]
[In General Formula (8), R₂₁, R₂₂, R₂₃ and R₂₄ each independently represents a hydrogen atom, a hydroxyl group, an amino group or a carboxyl group, and at least one of R₂₁, R₂₂, R₂₃ and R₂₄ represents a hydroxyl group, an amino group or a carboxyl group.]

Regarding the content of the aromatic compounds contained in the curing agent in the resin composition, 30 to 500 parts by mass or 40 to 300 parts by mass of the aromatic compound may be contained with respect to 100 parts by mass of the epoxy compound. With such a content, it is possible to increase the crosslinking density of the cured product.

The inorganic particles include boron nitride particles and particles (inorganic particles) different from boron nitride particles. The boron nitride particles may contain hexagonal boron nitride particles or the outer shape thereof may be scaly.

The content of boron nitride particles is 3 to 35 vol % and preferably 3 to 30 vol % based on the total of components other than the solvent. Examples of components other than the solvent include a main agent, a curing agent, inorganic particles and a curing accelerator. When the content of boron nitride particles is excessive, the minimum melt viscosity increases and an excellent filling property tends to be impaired. On the other hand, when the content of boron nitride particles is too small, the interaction (π-π stacking) with π-electrons of the aromatic rings contained in the aromatic compound tends to be weak, and the tracking resistance tends to be impaired.

Examples of inorganic particles different from boron nitride particles include magnesium oxide particles, alumina particles, aluminum hydroxide particles, aluminum nitride particles, magnesium oxide particles and silica particles. Among these, magnesium oxide particles are preferably included. Since magnesium oxide particles have lower hardness than other inorganic particles, for example, it is possible to improve workability of the laminate substrate therewith. Here, inorganic particles different from boron nitride particles are not limited to being of one type, and two or more types thereof may be contained.

A total content of boron nitride particles and inorganic particles different from boron nitride particles is 40 to 75 vol % and preferably 40 to 70 vol % based on the total of the main agent, the curing agent, and inorganic particles. When the total content of inorganic particles is excessive, the minimum melt viscosity increases and an excellent filling property tends to be impaired. On the other hand, when the total content of inorganic particles is too small, an excellent heat dissipation property and tracking resistance tend to be impaired.

The resin composition may contain optional components other than the above components. Examples of optional components include a curing accelerator (curing catalyst) such as phosphines and imidazoles (2-ethyl-4-methylimidazole, etc.), a coupling agent such as a silane coupling agent and a titanate coupling agent, a flame retardant such as halogen and a phosphorus compound, a solvent (diluent), a plasticizer, and a lubricant. In addition, a curing agent other than an aromatic compound such as amines and acid anhydrides may be included. Specific examples of the curing agent other than an aromatic compound such as amines and acid anhydrides include a curing agent which is a phosphorus-containing aromatic compound. The content of the curing accelerator in the resin composition is, for example, 0.1 to 5 parts by mass, with respect to a total of 100 parts by mass of the main agent and the curing agent. The content of the solvent in the resin composition is, for example, 0 to 500 parts by mass, with respect to a total of 100 parts by mass of the main agent and the curing agent. Here, among the above optional components, a component that is a solid at room temperature (20° C.) is included in the solid content of the resin composition.

The resin composition of the present embodiment has an excellent filling property because the minimum melt viscosity is sufficiently low. In addition, the cured product of the resin composition of the present embodiment also has an excellent heat dissipation property because it has high thermal conductivity. In addition, the cured product also has excellent tracking resistance.

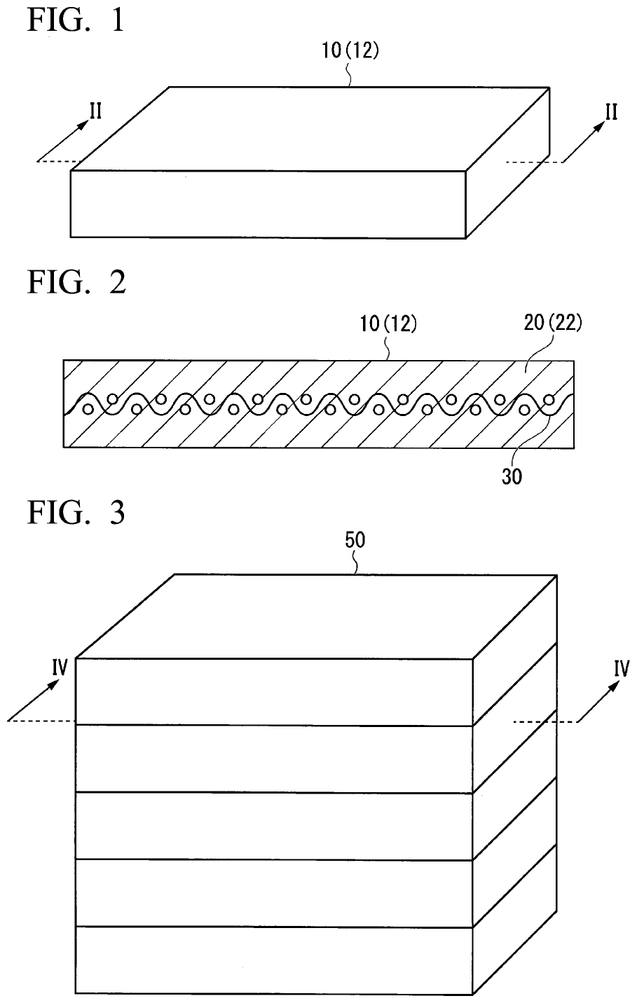

FIG. 1 is a perspective view of a resin sheet according to an embodiment. A resin sheet 12 is a sheet obtained by molding a resin composition. The resin sheet 12 may contain the resin composition without any change or may be in a B stage state. The resin sheet 12 can be used as a precursor of a resin substrate containing a cured product of the resin composition.

FIG. 2 is a cross-sectional view taken along the line II-II in FIG. 1. That is, FIG. 2 shows a cross section of the resin sheet 12 in FIG. 1 cut in the thickness direction. The resin sheet 12 includes a core material 30 and a resin component 22 that is impregnated into the core material 30 and covers the core material 30. The resin component 22 may be a resin composition or may be a semi-cured product of the resin composition. Examples of the core material 30 include woven fabrics and non-woven fabrics including at least one type of fiber selected from among glass fibers, carbon fibers, metal fibers, natural fibers, and synthetic fibers such as polyester fibers and polyamide fibers. However, the core material 30 is not limited thereto.

The resin sheet 12 can be produced as follows. According to a method of application, immersion, or the like, a resin composition is impregnated into the core material 30, and then heated to dry the resin composition. Accordingly, the solvent contained in the resin composition is removed. In some cases, at least a part of the resin composition may be semi-cured to form the resin component 22, and the resin sheet 12 may be formed. Heating conditions in this case may be, for example, at 60 to 150° C. for about 1 to 120 minutes, or may be at 70 to 120° C. for about 3 to 90 minutes. The resin sheet 12 may be composed of the resin component 22 containing a resin composition or may be composed of the resin component 22 in a B stage state.

When the resin sheet 12 is heated under heating conditions at a higher temperature, curing of the resin component 22 in a semi-cured state further proceeds and a cured product (thermosetting product) is formed. Accordingly, a resin substrate 10 containing a cured product 20 is obtained. Heating conditions in this case may be, for example, at 100 to 250° C. for about 1 to 300 minutes. Heating may be performed under pressurization or depressurization as necessary. The resin substrate 10 includes the core material 30 and the cured product 20 that covers the core material 30. In another embodiment, the resin substrate may be composed of only a cured product of a resin composition.

The cured resin product may be produced by heating the resin sheet 12 molded into a sheet form as described above, or may be produced by heating, for example, an amorphous resin composition such as an adhesive. The resin sheet 12 may be formed of only the resin component 22 without including the core material 30. In addition, a metal foil such as a copper foil may be laminated on the surface of the resin sheet 12.

Since the resin sheet 12 is obtained by molding the resin composition, the resin sheet 12 has an excellent filling property. In addition, it is possible to obtain a cured resin product, resin substrate and laminate substrate having an excellent heat dissipation property and tracking resistance using the resin sheet 12.

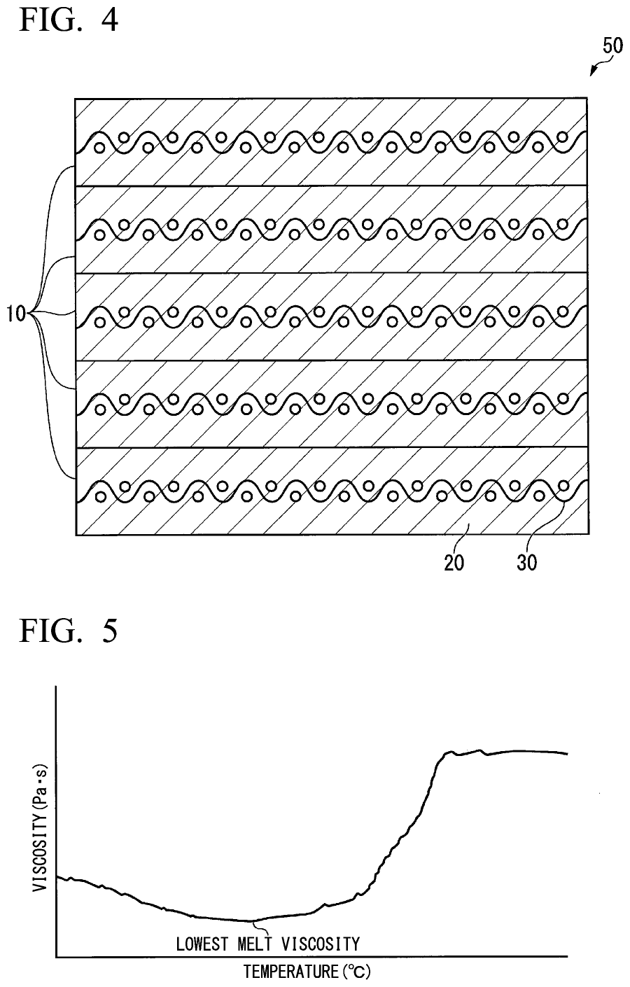

FIG. 3 is a perspective view of a laminate substrate according to an embodiment. FIG. 4 is a cross-sectional view taken along the line IV-IV in FIG. 3. That is, FIG. 4 shows a cross section of a laminate substrate 50 in FIG. 3 cut in the lamination direction. As shown in FIG. 3 and FIG. 4, the laminate substrate 50 is formed by laminating a plurality of resin substrates 10 containing the cured product 20. Regarding the laminate substrate 50, for example, a plurality of resin substrates 10 or resin sheets 12 that are superimposed are heated and/or pressurized to obtain a laminate substrate 100. Heating conditions are, for example, at 100 to 250° C. for about 1 to 300. Pressurization conditions are, for example, about 0.5 to 20 MPa. In addition, pressurization is not essential and heating may be performed under depressurization or a vacuum.

The resin substrate 10 included in the laminate substrate 50 includes the core material 30 and the resin component 22 that covers the core material 30. The laminate substrate 50 may be a metal-clad laminate board having a metal layer on the main surface. For the metal layer, various known materials may be appropriately selected and used. The metal layer may be, for example, a metal plate of copper, nickel, aluminum, or the like, or a metal foil. The thickness of the metal layer is not particularly limited, and is, for example, about 3 to 150 μm. The laminate substrate may be metal-clad laminate board that is subjected to etching and/or drilling

Since the resin substrate 10 and the laminate substrate 50 include a cured product of the resin composition, they have an excellent heat dissipation property and tracking resistance.

While some embodiments of the present invention have been described above, the present invention is not limited to the embodiments. For example, the laminate substrate may have an inner layer circuit between a plurality of resin substrates. While details of the present invention will be described below in more detail with reference to examples and comparative examples, the present invention is not limited to the following examples.

### EXAMPLES 1 TO 12, AND COMPARATIVE EXAMPLES 1 TO 6

### Preparation of Resin Composition

The following epoxy compound was prepared as a main agent. In all of the examples and comparative examples, the same epoxy compound was used. Epoxy compound: YL-6121H (product name, commercially available from Mitsubishi Chemical Corporation, epoxy equivalent: 175 g/eq)

The epoxy compound was a mixture in which tetramethylbiphenol type epoxy resin and 4,4′-biphenol type epoxy resin were contained at a ratio of about 1:1.

The following curing agents A to J were prepared as curing agents. The curing agent A was 4,4′-biphenyl dimethanol represented by the following Formula (A).

The curing agent B was 2,6-diphenylphenol represented by the following Formula (B).

The curing agent C was 2,3′,4,5′,6-pentaphenyl-3,4′-biphenyldiamine represented by the following Formula (C).

The curing agent D was 1,3,5-tris(4-carboxyphenyl)benzene represented by the following Formula (D).

The curing agent E was N,N,N′,N′-tetrakis(4-aminophenyl)benzidine represented by the following Formula (E).

The curing agent F was α,α,α′-tris(4-hydroxyphenyl)-1-ethyl-4-isopropylbenzene represented by the following Formula (F).

The curing agent G was 1,3,5-tris(4-hydroxyphenyl)benzene represented by the following Formula (G).

The curing agent H was 10-(2,5-dihydroxyphenyl)-9,10-dihydro 9-oxa-10-phosphaphenanthrene-10-oxide represented by the following Formula (H).

The curing agent I was [bis(4-hydroxyphenyl)methyl]diphenyl phosphine oxide represented by the following Formula (I).

The curing agent J was tris(p-hydroxyphenyl)phosphine represented by the following Formula (J).

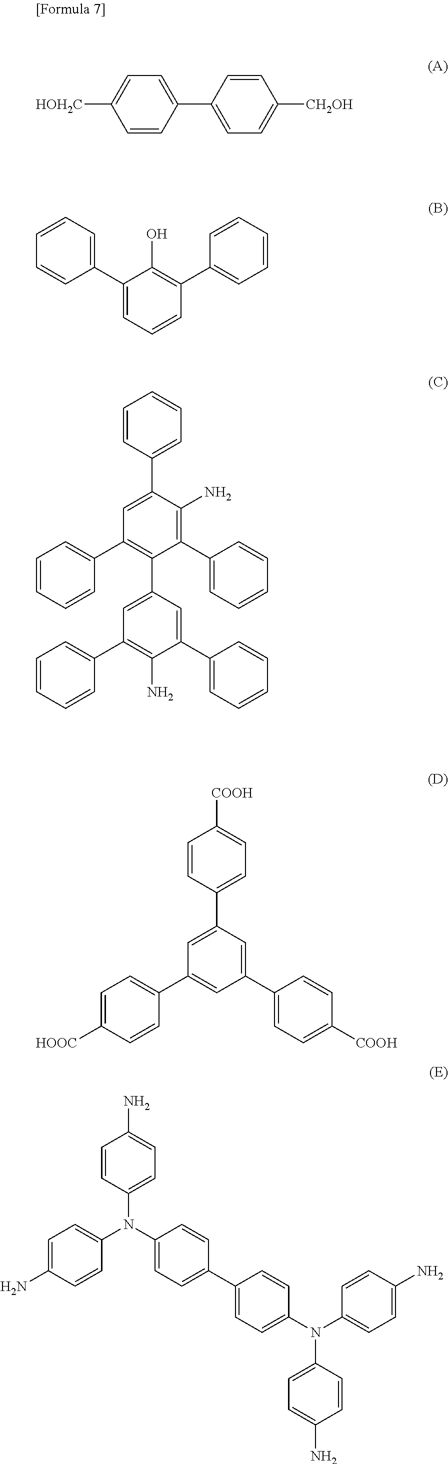 [SMILES: OCc1ccc(-c2ccc(CO)cc2)cc1 ; Oc1c(-c2ccccc2)cccc1-c1ccccc1 ; Nc1c(-c2ccccc2)cc(-c2c(-c3ccccc3)cc(-c3ccccc3)c(N)c2-c2ccccc2)cc1-c1ccccc1 ; O=C(O)c1ccc(-c2cc(-c3ccc(C(=O)O)cc3)cc(-c3ccc(C(=O)O)cc3)c2)cc1 ; Nc1ccc(N(c2ccc(N)cc2)c2ccc(-c3ccc(N(c4ccc(N)cc4)c4ccc(N)cc4)cc3)cc2)cc1]

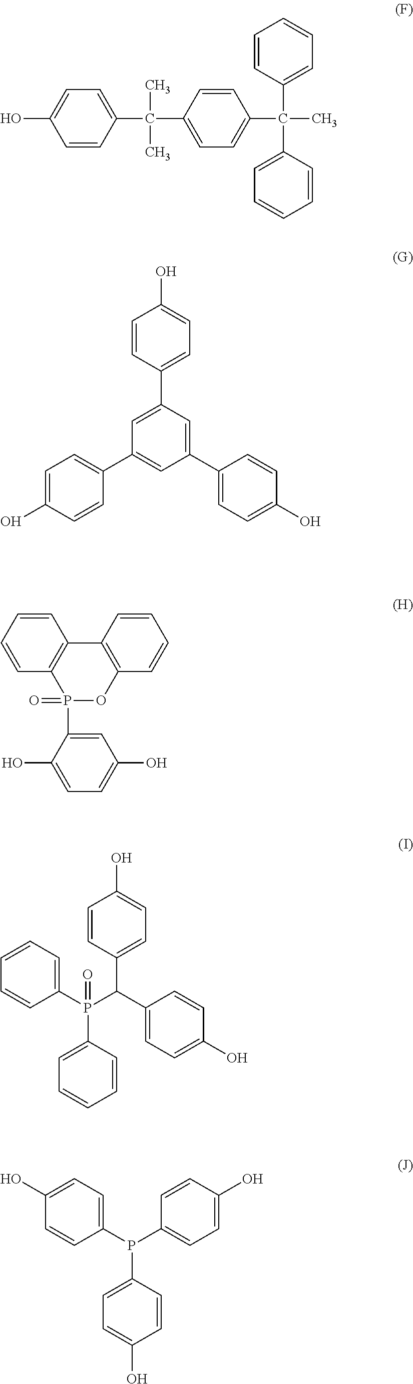 [SMILES: CC(C)(c1ccc(O)cc1)c1ccc(C(C)(c2ccccc2)c2ccccc2)cc1 ; Oc1ccc(-c2cc(-c3ccc(O)cc3)cc(-c3ccc(O)cc3)c2)cc1 ; O=P1(c2cc(O)ccc2O)Oc2ccccc2-c2ccccc21 ; O=P(c1ccccc1)(c1ccccc1)C(c1ccc(O)cc1)c1ccc(O)cc1 ; Oc1ccc(P(c2ccc(O)cc2)c2ccc(O)cc2)cc1]

The following commercially available inorganic particles A, B, and C were prepared.

Inorganic particles A: boron nitride particles (scaly, average particle size: 8 μm)
Inorganic particles B: magnesium oxide particles (average particle size: 50 μm)
Inorganic particles C: alumina particles (average particle size: 45 μm)

2-Ethyl-4-methylimidazole (commercially available from Shikoku Chemical Corporation, product name: 2E4MZ) was prepared as a curing accelerator, and methyl ethyl ketone was prepared as a solvent. The above main agent, one of the curing agents A to G, at least one of the inorganic particles A to C, the curing accelerator, and the solvent were mixed to prepare resin compositions of examples and comparative examples. The curing agent and the inorganic particles used in the examples and the comparative examples are shown in Table 1. In addition, the contents of respective raw materials are shown in Table 1.

Although the curing accelerator and the solvent are not shown in Table 1, in the examples and the comparative examples, 1 part by mass of the curing accelerator and 94 parts by mass of the solvent were added with respect to a total of 100 parts by mass of the epoxy compound and the curing agent.

### Production of Laminate Substrate

A glass fiber woven fabric with a thickness of 0.1 mm was impregnated into the resin compositions prepared in the examples and the comparative examples. Then, heating was performed at 100° C. for drying, methyl ethyl ketone was removed, and thereby a resin sheet was obtained. Six of the obtained resin sheets were laminated, and subjected to a heating and pressurization treatment for 20 minutes under conditions of a temperature of 170° C. and a pressure of 1 MPa. In addition, a heating and pressurization treatment was performed for 1 hour under conditions of a temperature of 200° C. and a pressure 4 MPa. In this manner, the heating and pressurization treatment was performed twice, and thereby a laminate substrate with a thickness of 1.0 mm including the glass fiber woven fabric and a cured product covering the same was obtained.

### Evaluation of Thermal Conductivity

The laminate substrates of the examples and the comparative examples were processed into a disk shape with a diameter of 10 mm and a thickness of 1.0 mm to produce test pieces. The thermal diffusion coefficient α[m²/s] of the test pieces was measured using a thermal conductivity measuring device (commercially available from Advance Riko, Inc., device name: laser flash method thermal constant measuring device). The specific heat Cₚ[J/(kg·K)] of the test pieces was measured through differential thermal analysis (DSC). In this case, measurement was performed using sapphire as a standard sample. The density r(kg/m³) of the test pieces was measured according to the Archimedes method. The thermal conductivity λ[W/(m·K)] was calculated using these measured values according to the following Formula (2). The results are shown in Table 1.

λ=α×Cₚ×r (2)

### Evaluation of Tracking Resistance

The tracking resistance was evaluated according to the following procedures based on JIS C2134. The laminate substrates of the examples and the comparative examples were processed into a rectangular shape of length×width×thickness=20 mm×20 mm×1 mm to produce test pieces. A plurality of such test pieces were produced. Only two electrodes each having a platinum tip and a shape with a width of 5 mm, a thickness of 2 mm, and a tip angle of 30° were brought into contact with the surface of the produced test piece. In this case, an interval between two electrodes was 4.0±0.1 mm, and a load of each of the electrodes was 1±0.05 N.

A predetermined test voltage (sine wave voltage) was applied between two electrodes. 50 drops of an electrolytic solution (an aqueous solution containing 0.1±0.002 mass % of ammonium chloride, resistivity 3.95±0.05 Ω·m) was added dropwise to the test piece to which a test voltage was applied at intervals of 30±5 seconds. In a test piece in which a current of 0.5 A or higher flowed between two electrodes for 2 seconds or longer, it was determined that a tracking phenomenon was caused (it was broken). The test voltage was in a range of 100 to 600 V in 25 V increments. At respective test voltages, the test was performed at n=5, and a maximum voltage at which all of five test pieces did not break (tracking phenomenon did not occur) was obtained. The results are shown in Table 1.

### Evaluation of Minimum Melt Viscosity

A minimum melt viscosity was measured according to the following procedures using a rotary rheometer (commercially available from Thermo Fisher Scientific K.K., product name: Rheo Stress 6000). The laminate substrates of the examples and the comparative examples were processed into a disk shape (diameter=20 mm, thickness h=1.8 mm) to produce test pieces. While the test pieces were heated under conditions of start temperature=100° C., heating rate=2.5° C./min, and frequency=1 Hz, the upper plate was moved at a predetermined speed with respect to the lower plate, and the viscosity at each temperature was obtained. Measurement was performed up to a temperature of 180° C., and the change in viscosity according to the temperature was measured.

FIG. 5 is a graph showing the change in viscosity of Example 1. As shown in FIG. 5, a downward convex viscosity curve was obtained. This shows that the test piece melted as the temperature increased and the viscosity decreased once, and the viscosity then increased as the curing reaction proceeded. In the viscosity curve shown in FIG. 5, the lowest value of the viscosity was set as a minimum melt viscosity. The results are shown in Table 1.

TABLE 1

| | Curing agent | | | | | | | |
|---|---|---|---|---|---|---|---|---|
| | | | Number | Content | First inorganic | | Second inorganic | |
| | | | of | (parts | particles | | particles | |
| | | Ratio | benzene | by | | Content | | Content |
| | Type | (%) | rings | mass) | Type | (volume %) | Type | (volume %) |
| Example 1 | A | 86 | 2 | 61 | A | 3 | B | 37 |
| Example 2 | A | 86 | 2 | 61 | A | 30 | B | 10 |
| Example 3 | A | 86 | 2 | 61 | A | 3 | B | 67 |
| Example 4 | A | 86 | 2 | 61 | A | 3 | B | 20 |
| Example 5 | B | 100 | 3 | 141 | A | 3 | B | 37 |
| Example 6 | C | 100 | 7 | 323 | A | 3 | B | 37 |
| Example 7 | D | 89 | 4 | 63 | A | 3 | B | 37 |
| Example 8 | E | 100 | 6 | 39 | A | 3 | B | 37 |
| Example 9 | G | 100 | 4 | 67 | A | 3 | B | 37 |
| Example 10 | H | 100 | 3 | 93 | A | 3 | B | 37 |
| Example 11 | I | 100 | 4 | 114 | A | 3 | B | 37 |
| Example 12 | J | 100 | 3 | 59 | A | 3 | B | 37 |
| Comparative | F | 83 | 4 | 81 | A | 3 | B | 37 |
| Example 1 | | | | | | | | |
| Comparative | A | 86 | 2 | 61 | C | 3 | B | 37 |
| Example 2 | | | | | | | | |
| Comparative | A | 86 | 2 | 61 | A | 2 | B | 38 |
| Example 3 | | | | | | | | |
| Comparative | A | 86 | 2 | 61 | A | 40 | — | — |
| Example 4 | | | | | | | | |
| Comparative | A | 86 | 2 | 61 | A | 3 | B | 27 |
| Example 5 | | | | | | | | |
| Comparative | A | 86 | 2 | 61 | A | 3 | B | 77 |
| Example 6 | | | | | | | | |

| | | | Total | | | |
|---|---|---|---|---|---|---|
| | Third inorganic | | content of | | | Minimum |
| | particles | | inorganic | Thermal | Maximum | melt |
| | | Content | particles | conductivity | voltage | viscosity |
| | Type | (volume %) | (volume %) | (W/m · K) | (V) | (Pa · s) |
| Example 1 | — | — | 40 | 1.2 | 450 | 1000 |
| Example 2 | — | — | 40 | 2.2 | 500 | 5000 |
| Example 3 | — | — | 70 | 6.0 | 500 | 6000 |
| Example 4 | C | 17 | 40 | 1.1 | 450 | 1000 |
| Example 5 | — | — | 40 | 1.4 | 450 | 1200 |
| Example 6 | — | — | 40 | 1.6 | 425 | 5000 |
| Example 7 | — | — | 40 | 1.6 | 450 | 1300 |
| Example 8 | — | — | 40 | 1.6 | 425 | 2000 |
| Example 9 | — | — | 40 | 1.7 | 425 | 1200 |
| Example 10 | — | — | 40 | 1.5 | 450 | 1300 |
| Example 11 | — | — | 40 | 1.6 | 450 | 1500 |
| Example 12 | — | — | 40 | 1.5 | 450 | 1300 |
| Comparative | — | — | 40 | 0.9 | 450 | 1100 |
| Example 1 | | | | | | |
| Comparative | — | — | 40 | 1.0 | 350 | 500 |
| Example 2 | | | | | | |
| Comparative | — | — | 40 | 1.1 | 375 | 700 |
| Example 3 | | | | | | |
| Comparative | — | — | 40 | 2.5 | 525 | 11000 |
| Example 4 | | | | | | |
| Comparative | — | — | 30 | 0.9 | 375 | 200 |
| Example 5 | | | | | | |
| Comparative | — | — | 80 | 7.0 | 525 | 12000 |
| Example 6 | | | | | | |

In Table 1, the column “ratio” in the “curing agent” indicates a ratio of the number of carbon atoms constituting an aromatic ring to a total number of carbon atoms in one molecule of the curing agents A to J. The column “number of benzene rings” in the “curing agent” indicates the number of benzene rings in one molecule of the curing agents A to J. The column “content (parts by mass)” in the “curing agent” indicates parts by mass of the curing agent with respect to 100 parts by mass of the main agent (epoxy compound). The column “content (vol %)” in first inorganic particles, second inorganic particles, and third inorganic particles indicates a proportion (by volume) of respective inorganic particles based on a total volume of the main agent (epoxy compound), the curing agent, the first inorganic particles, the second inorganic particles and the third inorganic particles, and the curing accelerator.

A shown in Table 1, in all of Examples 1 to 12, the thermal conductivity was 1.0 W/(m·K) or more, the maximum voltage was 400 V or higher, and the minimum melt viscosity was 8,000 Pa·s or less. Specifically, it was confirmed that Examples 1 to 12 had sufficiently high levels of all the characteristics of a heat dissipation property, tracking resistance, and a filling property. On the other hand, Comparative Examples 1 to 6 had inferior at least one characteristic of the thermal conductivity, the maximum voltage, and the minimum melt viscosity to Examples 1 to 12.

### Second Embodiment

A second embodiment according to claims 6 to 13 of the present invention will be described below with reference to the drawings in some cases. However, the following embodiment is only an example for describing the present invention, and the present invention is not limited to the following content. In the description, the same components or components having the same functions are denoted with the same reference numerals and redundant descriptions will be omitted in some cases. In addition, the positional relationship such as top, bottom, left and right is based on the positional relationship shown in the drawings unless otherwise specified. In addition, the dimensional ratios of respective components are not limited to the illustrated ratios.

The resin composition of the present embodiment includes a main agent containing an epoxy compound, a curing agent, and inorganic particles. Here, the main agent is a component which is polymerized by a curing agent and forms a cured product together with the curing agent. Examples of the epoxy compound include bisphenol A type, bisphenol F type, glycidyl ether type, glycidyl ester type, and glycidyl amine type compounds. Among these, one epoxy compound may be used alone or a plurality of epoxy compounds may be used in combination. The epoxy equivalent of the epoxy compound may be, for example, 100 to 1000 g/eq.

In order to obtain higher thermal conductivity, the epoxy compound preferably has a mesogen framework in which two or more benzene rings are included such as a biphenyl framework or a terphenyl framework in the molecule. When such an epoxy compound is included, it is possible to improve the stackability of benzene rings together with aromatic compounds contained in the curing agent. When the stackability of benzene rings is improved, it is possible to further reduce scattering of phonons, which causes reduction in thermal conductivity, in the cured product. Accordingly, it is possible to further improve thermal conductivity and further improve a heat dissipation property.

The epoxy compound may include glycidyl ethers having a biphenyl framework and two or more epoxy groups in one molecule (for example, those having a biphenyl framework such as biphenyl glycidyl ether and tetramethyl biphenyl glycidyl ether), and glycidyl ethers having a mesogen framework such as a terphenyl framework. The epoxy compound may be a phosphorus-containing epoxy compound which include phosphorus. Accordingly, it is possible to further improve flame retardance.

The curing agent includes at least one phosphorus compound of the following General Formula (9) and General Formula (10), and an aromatic compound represented by General Formula (11).

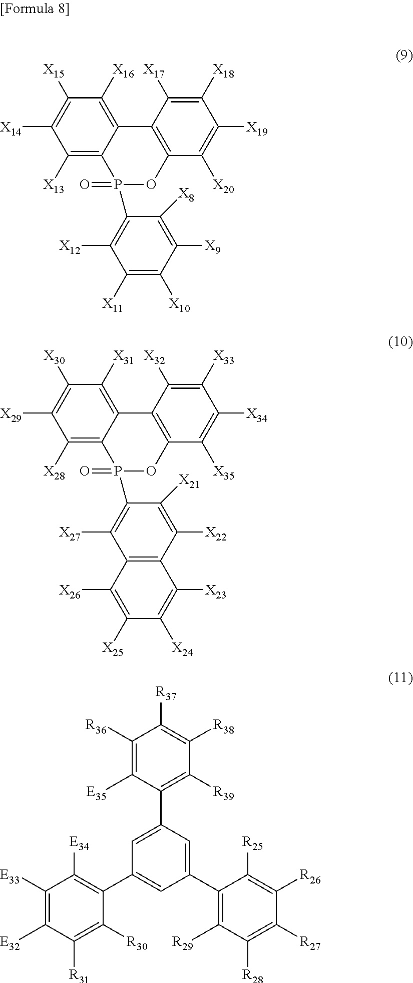

In General Formula (10), X₂₁ to X₃₅ each independently represents a hydrogen atom, an alkyl group or a hydroxy group, and at least one of X₂₁ to X₂₇ represents a hydroxy group. The alkyl group has, for example, 1 to 5 carbon atoms. Preferably, X₂₁ to X₂₇ each independently represents a hydrogen atom or a hydroxy group.

Since the phosphorus compound represented by General Formula (9) and General Formula (10) includes phosphorus, it contributes to improving flame retardance. In addition, since it is poorly soluble or insoluble in the organic solvent, it has an effect of improving dispersibility of the resin composition. In addition, since such phosphorus compounds have a biphenyl structure, they have relatively high thermal conductivity.

A melting point of the phosphorus compound represented by General Formula (9) and General Formula (10) is preferably 250° C. or higher. Accordingly, even after the resin composition is heated, the thermosetting reaction can proceed while the dispersibility is favorably maintained.

The content of the phosphorus compound represented by General Formula (9) and General Formula (10) is 8 parts by mass or more, and preferably 10 parts by mass or more with respect to a total of 100 parts by mass of organic components other than the solvent. The content of the phosphorus compound may be, for example, 30 parts by mass or less or 20 parts by mass or less with respect to a total of 100 parts by mass of organic components other than the solvent. Accordingly, the content of an aromatic compound to be described below can be secured and the thermal conductivity can increase sufficiently. Here, organic components other than the solvent in this specification correspond to the main agent, the curing agent, and optional components (organic substances). On the other hand, inorganic substances such as a solvent and inorganic particles do not correspond to the above organic components.

In General Formula (11), R₂₅ to R₃₉ each independently represents a hydrogen atom, a hydroxyl group or an amino group, and at least one of R₂₅ to R₃₉ represents a hydroxyl group or an amino group.

In the curing agent containing the aromatic compound of General Formula (11), aromatic rings easily overlap with each other due to the it-it stacking and an interval between benzene rings can be reduced. Therefore, the density of the cured product can increase, and the thermal conductivity can be improved. In addition, it is thought that reduction of scattering of molecular lattice vibration also contributes to improving thermal conductivity. Therefore, the cured product of the resin composition containing the aromatic compound has high thermal conductivity and an excellent heat dissipation property.

The aromatic compound represented by General Formula (11) may include derivatives of 1,3,5-triphenylbenzene.

Examples of triphenyl benzene derivatives include 1,3,5-tris(4-hydroxyphenyl)benzene and 1,3,5-tris(4-aminophenyl)benzene. In 1,3,5-tris(4-hydroxyphenyl)benzene, respective active hydrogen atoms of three hydroxyl groups in one molecule can react with epoxy groups in the epoxy compound. Accordingly, in the cured product, a strong resin structure having a high crosslinking density is formed. Therefore, it is possible to further improve a heat dissipation property and flame retardance. In 1,3,5-tris(4-aminophenyl)benzene, respective active hydrogen atoms of three amino groups in one molecule can react with epoxy groups in the epoxy compound. Accordingly, in the cured product, a strong resin structure having a high crosslinking density is formed. Therefore, it is possible to further improve a heat dissipation property and flame retardance.

The curing agent may include a compound other than the above phosphorus compound and aromatic compound. In order to sufficiently improve the thermal conductivity, the content of the aromatic compound with respect to a total amount of the curing agent is preferably 15 mass % or more, more preferably 30 mass % or more, and most preferably 40 mass % or more. On the other hand, in order to secure an amount of the phosphorus compound added, the content of the aromatic compound with respect to a total amount of the curing agent is, for example, 80 mass % or less, and more preferably 70 mass % or less. The curing agent may contain 1,3,5-tris(4-hydroxyphenyl)benzene and/or 1,3,5-tris(4-aminophenyl)benzene in the above content range. Accordingly, it is possible to further improve a heat dissipation property.

In order to sufficiently improve the dispersibility and the flame retardance, the content of the phosphorus compound with respect to a total amount of the curing agent is preferably 10 mass % or more, and more preferably 20 mass % or more. On the other hand, in order to secure an amount of the aromatic compound added, the content of the phosphorus compound with respect to a total amount of the curing agent is, for example, 40 mass % or less, and preferably 30 mass % or less.

Regarding the content ratio between the epoxy compound and the curing agent in the resin composition, 10 to 100 parts by mass or 20 to 80 parts by mass of the curing agent may be contained with respect to 100 parts by mass of the epoxy compound. With such a content, it is possible to increase the crosslinking density of the cured product.

The content of the elemental phosphorus in the resin composition is preferably 0.8 parts by mass or more, more preferably 1.3 parts by mass or more, and most preferably 1.5 parts by mass or more with respect to a total of 100 parts by mass of the epoxy compound and the curing agent. The flame retardance can be improved by the content of the elemental phosphorus.

Examples of inorganic particles include boron nitride particles, magnesium oxide particles, alumina particles, aluminum hydroxide particles, aluminum nitride particles, and silica particles. These can be used alone or two or more thereof can be used in combination. The content of inorganic particles is 200 to 700 parts by mass, and preferably 300 to 600 parts by mass with respect to a total of 100 parts by mass of the epoxy compound and the curing agent. When the content of inorganic particles is excessive, a filling property tends to be impaired. On the other hand, when the content of inorganic particles is too small, the tracking resistance tends to be impaired. Inorganic particles preferably include magnesium oxide particles in consideration of ease of processing for a resin substrate and a laminate substrate.

The average particle size based on the volume of inorganic particles measured using a commercially available laser diffraction type particle size distribution measuring device is, for example, 1 to 100 μm. The particle size distribution of inorganic particles measured by the measuring device may have a plurality of peaks. Accordingly, it is possible to increase the content of inorganic particles. Thus, inorganic particles having a plurality of peaks can be obtained by, for example, mixing two or more types of particles having different average particle sizes.

The resin composition may contain optional components other than the above components. Examples of optional components include a curing accelerator (curing catalyst) such as phosphines and imidazoles (2-ethyl-4-methylimidazole, etc.), a coupling agent such as a silane coupling agent and a titanate coupling agent, a flame retardant such as halogen, a solvent (diluent), a plasticizer, and a lubricant. In addition, a curing agent other than an aromatic compound such as amines and acid anhydride may be included. The content of the curing accelerator in the resin composition is, for example, 0 to 5 parts by mass, with respect to a total of 100 parts by mass of the main agent and the curing agent. The content of the solvent in the resin composition is, for example, 0 to 500 parts by mass, with respect to a total of 100 parts by mass of the main agent and the curing agent.

FIG. 1 is a perspective view of a resin sheet according to an embodiment. A resin sheet 12 is a sheet obtained by molding a resin composition. The resin sheet 12 may contain the resin composition without any change or may be in a B stage state. The resin sheet 12 can be used as a precursor of a resin substrate containing a cured product of the resin composition.

FIG. 2 is a cross-sectional view taken along the line II-II in FIG. 1. That is, FIG. 2 shows a cross section of the resin sheet 12 cut in the thickness direction. The resin sheet 12 includes the core material 30 and the resin component 22 that is impregnated into the core material 30 and covers the core material 30. The resin component 22 may be a resin composition or may be a semi-cured product of the resin composition. Examples of the core material 30 include woven fabrics and non-woven fabrics including at least one type of fiber selected from among glass fibers, carbon fibers, metal fibers, natural fibers, and synthetic fibers such as polyester fibers and polyamide fibers. However, the core material 30 is not limited thereto.

The resin sheet 12 can be produced as follows. According to a method of application, immersion, or the like, a resin composition is impregnated into the core material 30, and then heated to dry the resin composition. Accordingly, the organic solvent contained in the resin composition is removed. In some cases, at least a part of the resin composition may be semi-cured to form the resin component 22, and the resin sheet 12 may be formed. Heating conditions in this case may be, for example, at 60 to 150° C. for about 1 to 120 minutes, or may be at 70 to 120° C. for about 3 to 90 minutes. The resin sheet 12 may be composed of the resin component 22 containing a resin composition or may be composed of the resin component 22 in a B stage state.

When the resin sheet 12 is heated under heating conditions at a higher temperature, curing of the resin component 22 that is in an uncured or semi-cured state further proceeds, and a cured product (thermosetting product) is formed. Accordingly, the resin substrate 10 containing the cured product 20 is obtained. Heating conditions in this case may be, for example, at 100 to 250° C. for about 1 to 300 minutes. Heating may be performed under pressurization or depressurization as necessary. The resin substrate 10 includes the core material 30 and the cured product 20 that covers the core material 30. In another embodiment, the resin substrate may be composed of only a cured product of a resin composition.

The cured resin product may be produced by heating the resin sheet 12 molded into a sheet form as described above, or may be produced by heating, for example, an amorphous resin composition such as an adhesive. The resin sheet 12 may be formed of only the resin component 22 without including the core material 30. In addition, a metal foil such as a copper foil may be laminated on the surface of the resin sheet 12.

Since the resin sheet 12 is obtained by molding the resin composition, the resin sheet 12 has excellent uniformity. In addition, it is possible to obtain a cured resin product, resin substrate, and laminate substrate having an excellent heat dissipation property and flame retardance using the resin sheet 12.

FIG. 3 is a perspective view of a laminate substrate according to an embodiment. FIG. 4 is a cross-sectional view taken along the line IV-IV in FIG. 3. FIG. 4 shows a cross section of the laminate substrate cut in the lamination direction. As shown in FIG. 3 and FIG. 4, the laminate substrate 50 is formed by laminating a plurality of resin substrates 10 containing the cured product 20. Regarding the laminate substrate 50, for example, a plurality of resin substrates 10 or resin sheets 12 that are superimposed are heated and/or pressurized to obtain a laminate substrate 100. Heating conditions are, for example, at 100 to 250° C. for about 1 to 300 minutes. Pressurization conditions are, for example, about 0.1 to 10 MPa. Here, pressurization is not essential, and heating may be performed under depressurization or vacuum.

The resin substrate 10 included in the laminate substrate 50 includes the core material 30 and the resin component 22 that covers the core material 30. The laminate substrate 50 may be a metal-clad laminate board having a metal layer on the main surface. For the metal layer, various known materials may be appropriately selected and used. The metal layer may be, for example, a metal plate of copper, nickel, aluminum, or the like, or a metal foil. The thickness of the metal layer is not particularly limited, and is, for example, about 3 to 150 μm. The laminate substrate may be metal-clad laminate board that is subjected to etching and/or drilling.

Since the resin substrate 10 and the laminate substrate 50 include a cured product of the resin composition, they have an excellent heat dissipation property and flame retardance. In addition, the variation in quality is small and the uniformity of quality is excellent.

While some embodiments of the present invention have been described above, the present invention is not limited to the embodiments. For example, the laminate substrate may have an inner layer circuit between a plurality of resin substrates. While details of the present invention will be described below in more detail with reference to examples and comparative examples, the present invention is not limited to the following examples.

### EXAMPLES 13 TO 22, AND COMPARATIVE EXAMPLES 7 TO 12

### Preparation of Resin Composition

The following epoxy compounds were prepared as main agents

Epoxy compound A: commercially available product (product name: YL-6121H, commercially available from Mitsubishi Chemical Corporation, epoxy equivalent: 175 g/eq)
Epoxy compound B: commercially available product (product name: 840-S, commercially available from DIC, epoxy equivalent: 185 g/eq)
Epoxy compound C: commercially available product (product name: 830-S, commercially available from DIC, epoxy equivalent: 173 g/eq)
Epoxy compound D: commercially available product (phosphorus-containing epoxy compound, phosphorus content: 5 mass %, epoxy equivalent: 763 g/eq)

The epoxy compound A was a mixture in which tetramethylbiphenol type epoxy resin and 4,4′-biphenol type epoxy resin were contained at a ratio of about 1:1. The epoxy compound B was a bisphenol A type liquid epoxy resin. The epoxy compound C was a bisphenol F type liquid epoxy resin. The epoxy compound D was a phosphorus-containing epoxy resin.

The following curing agents K to R were prepared as curing agents.

The curing agent K was 10-(2,5-dihydroxyphenyl)-9,10-dihydro-9-oxa-10-phosphaphenanthrene-10-oxide represented by the following Formula (K) (melting point: 250° C.).

The curing agent L was 10-[2-(dihydroxynaphthyl)]-9,10-dihydro-9-oxa-10-phosphaphenanthrene-10-oxide represented by the following Formula (L)(melting point: 290° C.).

The curing agent M was 1,3,5-tris(4-hydroxyphenyl)benzene represented by the following Formula (M).

The curing agent N was 1,3,5-tris(4-aminophenyl)benzene represented by the following Formula (N). The curing agent O was a commercially available novolak type phenolic resin (commercially available from DIC, product name: TD-2093).

The curing agent P was a compound represented by the following Formula (P).

The curing agent Q was a compound represented by the following Formula (Q).

The curing agent R was a compound represented by the following Formula (R).

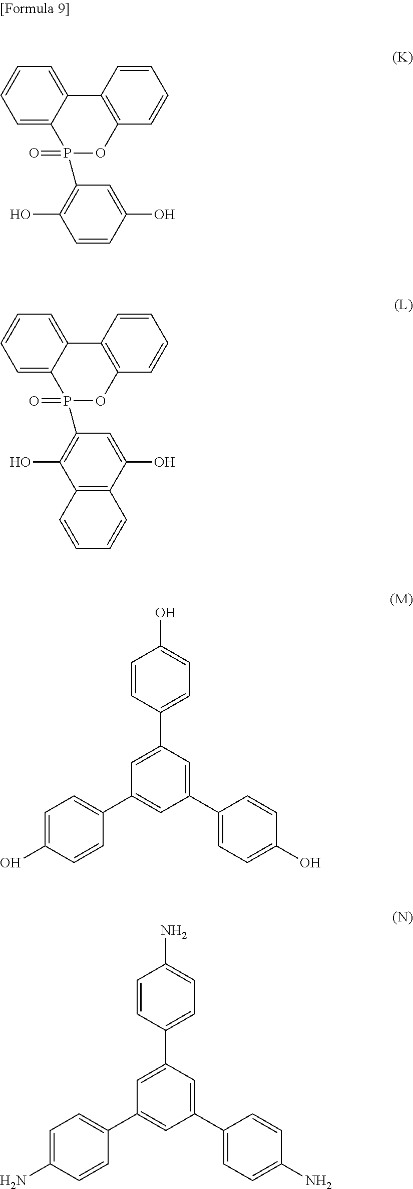 [SMILES: O=P1(c2cc(O)ccc2O)Oc2ccccc2-c2ccccc21 ; O=P1(c2cc(O)c3ccccc3c2O)Oc2ccccc2-c2ccccc21 ; Oc1ccc(-c2cc(-c3ccc(O)cc3)cc(-c3ccc(O)cc3)c2)cc1 ; Nc1ccc(-c2cc(-c3ccc(N)cc3)cc(-c3ccc(N)cc3)c2)cc1]

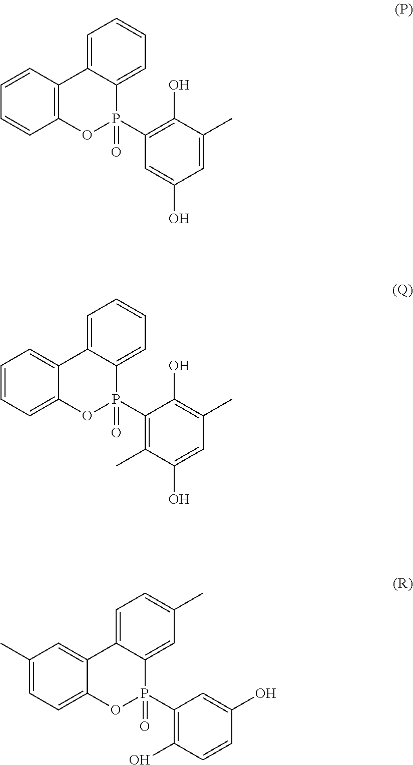

The following commercially available inorganic particles were prepared.

Inorganic particles A: magnesium oxide particles (commercially available from Ube Material Industries, average particle size: 50 μm)

Inorganic particles B: magnesium oxide particles (commercially available from Ube Material Industries, average particle size: 10 μm)

2-Ethyl-4-methylimidazole (commercially available from Shikoku Chemical Corporation, product name: 2E4MZ) was prepared as a curing accelerator, and methyl ethyl ketone was prepared as a solvent. The above main agents, at least one of the curing agents K to R, inorganic particles, the curing accelerator, and the solvent (methyl ethyl ketone) were mixed to prepare resin compositions of the examples and the comparative examples. The main agents and the curing agents used in the examples and the comparative examples are shown in Table 2. In addition, the contents of respective raw materials with respect to a total of 100 parts by mass of the main agent and the curing agent are shown in Table 2.

Although the inorganic particles, the curing accelerator, and the solvent are not shown in Table 2, in the examples and the comparative examples, 150 parts by mass of each of the inorganic particles A and B, 1 part by mass of the curing accelerator, and 80 parts by mass of the solvent were added with respect to a total of 100 parts by mass of the main agent and the curing agent.

### Evaluation of Dispersibility

Respective raw materials were mixed to obtain a resin composition made from a dispersion solution containing a main agent, a curing agent, inorganic particles, a curing accelerator, and a solvent. After the dispersion solution was sufficiently stirred, the dispersion solution was poured into a graduated cylinder (capacity: 30 ml) so that its height became 10 cm. After it was left for 1 hour, a glass rod was put into the dispersion solution in the graduated cylinder, and it was checked whether the tip of the glass rod was in contact with the inner bottom of the graduated cylinder. When the tip was in contact, it was evaluated that sedimentation of inorganic particles was reduced (evaluation A). On the other hand, when the tip was not in contact, it was evaluated that sedimentation of inorganic particles was not reduced (evaluation B). The examples and evaluation results of the examples are shown in Table 1.

### Production of Laminate Substrate

The resin composition made from a dispersion solution was applied to a release film to obtain a coating film with a thickness of 200 The coating film was heated to 80° C. and dried to prepare a resin sheet having a solvent content of 1 mass %. Five resin sheets were laminated and heated at 200° C. for 1 hour to obtain a laminate substrate with a thickness of about 1 mm.

### Evaluation of Thermal Conductivity

The produced laminate substrates of the examples and the comparative examples were cut into a disk shape with a diameter of 10 mm to produce test pieces. A thermal diffusion coefficient α[m²/s] of the test piece was measured using a laser flash method thermal conductivity measuring device (commercially available from Advance Riko, Inc., device name: TC-7000). A specific heat Cₚ[J/(kg·K)] of the test piece was measured through differential thermal analysis (DSC). In this case, measurement was performed using sapphire as a standard sample. The density r(kg/m³) of the test pieces was measured according to the Archimedes method. The thermal conductivity λ[W/(m·K)] was calculated using these measured values according to the following Formula (3). The results are shown in Table 2.

λ=α×Cₚ×r (3)

### Evaluation of Flame Retardance

The produced laminate substrates were cut to a size with a length of 125 mm×a width of 13 mm to produce test pieces. The flame retardance test of the test pieces was performed according to a vertical test method (UL94 V method) defined in UL94. Then, evaluation was performed based on evaluation criteria (V-0, V-1, V-2) defined in UL94. Those that satisfied evaluation criteria V-0, V-1, and V-2 defined in UL94 were evaluated as “V-0,” “V-1,” and “V-2.” In addition, those that did not satisfy any of the criteria were evaluated as “combustion.” The results are shown in Table 2.

TABLE 2

| | Name of raw | Examples | | | | | | | | | |
|---|---|---|---|---|---|---|---|---|---|---|---|
| Component | materials | 13 | 14 | 15 | 16 | 17 | 18 | 19 | 20 | 21 | 22 |
| Main agent | Epoxy | 57.2 | | | 56.3 | 58.4 | 16.9 | 67.5 | 56.9 | 56.6 | 56.6 |
| | compound A | | | | | | | | | | |
| | Epoxy | | 58.5 | | | | | | | | |
| | compound B | | | | | | | | | | |
| | Epoxy | | | 56.9 | | | | | | | |
| | compound C | | | | | | | | | | |
| | Epoxy | | | | | | 60.2 | | | | |
| | compound D | | | | | | | | | | |
| Curing agent | Curing agent | 15.6 | 15.7 | 15.6 | | 8.3 | 8.0 | 15.6 | 15.7 | 15.7 | 15.7 |
| | K | | | | | | | | | | |
| | Curing agent | | | | 15.6 | | | | | | |
| | L | | | | | | | | | | |
| | Curing agent | 27.2 | 25.9 | 27.5 | 28.1 | 33.3 | 14.9 | | | | |
| | M | | | | | | | | | | |
| | Curing agent | | | | | | | 16.9 | | | |
| | N | | | | | | | | | | |
| | Curing agent | | | | | | | | | | |
| | O | | | | | | | | | | |
| | Curing agent | | | | | | | | 27.4 | | |
| | P | | | | | | | | | | |
| | Curing agent | | | | | | | | | 27.7 | |
| | Q | | | | | | | | | | |
| | Curing agent | | | | | | | | | | 27.7 |
| | R | | | | | | | | | | |

| Content | | | | | | | | | | |
|---|---|---|---|---|---|---|---|---|---|---|
| Elemental phosphorus (parts by | 1.5 | 1.5 | 1.5 | 1.5 | 0.8 | 3.8 | 1.5 | 1.5 | 1.5 | 1.5 |
| mass) | | | | | | | | | | |
| Phosphorus compound (parts by | 16 | 16 | 16 | 16 | 8 | 8 | 16 | 16 | 16 | 16 |
| mass) | | | | | | | | | | |
| Aromatic compound (parts by mass) | 27 | 26 | 28 | 28 | 33 | 15 | 17 | 27 | 28 | 28 |
| Proportion of curing agents M, N, P, | 64 | 62 | 64 | 64 | 80 | 65 | 52 | 64 | 64 | 64 |
| Q, and R (mass %) | | | | | | | | | | |
| Evaluation | | | | | | | | | | |
| Dispersibility | A | A | A | A | A | A | A | A | A | A |
| Thermal conductivity (W/m · K) | 3.2 | 3.0 | 3.0 | 3.2 | 3.3 | 2.8 | 3.5 | 3.2 | 3.2 | 3.2 |
| Flame retardance | V-0 | V-0 | V-0 | V-0 | V-1 | V-0 | V-0 | V-0 | V-0 | V-0 |

| | | Comparative | | | | | |
|---|---|---|---|---|---|---|---|
| | Name of raw | Examples | | | | | |
| Component | materials | 7 | 8 | 9 | 10 | 11 | 12 |
| Main agent | Epoxy | 59.7 | 59.2 | 58.5 | | | 56.7 |
| | compound A | | | | | | |
| | Epoxy | | | | | 40.0 | |
| | compound B | | | | | | |
| | Epoxy | | | | | | |
| | compound C | | | | | | |
| | Epoxy | | | | 86.6 | 30.0 | 2.8 |
| | compound D | | | | | | |
| Curing agent | Curing agent | | 15.6 | 7.3 | | | 6.9 |
| | K | | | | | | |
| | Curing agent | | | | | | |
| | L | | | | | | |
| | Curing agent | 40.3 | | 34.2 | 13.4 | 30.0 | 33.6 |
| | M | | | | | | |
| | Curing agent | | | | | | |
| | N | | | | | | |
| | Curing agent | | 25.2 | | | | |
| | O | | | | | | |
| | Curing agent | | | | | | |
| | P | | | | | | |
| | Curing agent | | | | | | |
| | Q | | | | | | |
| | Curing agent | | | | | | |
| | R | | | | | | |

| Content | | | | | | |
|---|---|---|---|---|---|---|
| Elemental phosphorus (pails by | 0 | 1.5 | 0.7 | 4.3 | 1.5 | 0.8 |
| mass) | | | | | | |
| Phosphorus compound (parts by | 0 | 16 | 7 | 0 | 0 | 7 |
| mass) | | | | | | |
| Aromatic compound (parts by mass) | 40 | 0 | 34 | 13 | 30 | 34 |
| Proportion of curing agents M, N, P, | 100 | 0 | 82 | 100 | 100 | 83 |
| Q, and R (mass %) | | | | | | |
| Evaluation | | | | | | |
| Dispersibility | B | A | B | B | B | B |
| Thermal conductivity (W/m · K) | 3.6 | 2.0 | 3.3 | 2.3 | 2.4 | 3.0 |
| Flame retardance | Combustion | V-0 | Combustion | V-0 | V-0 | V-1 |

In Table 2, the contents (parts by mass) of the elemental phosphorus, the phosphorus compound (the curing agents K and L), and the aromatic compound (the curing agents M and N) indicate the contents with respect to a total of 100 parts by mass of organic components (the main agent, the curing agent, and the curing accelerator) other than the solvent contained in the resin composition. In Table 2, proportions (mass %) of the curing agents M, N, P, Q, and R indicate proportions by mass based on a total amount of the curing agent.

As shown in Table 2, in Examples 13 to 22, the dispersibility was evaluated as “A.” In addition, the thermal conductivity was 2.5 W/m·K or more, the flame retardance was V-1 or higher, it was confirmed that a cured product having an excellent heat dissipation property was formed. On the other hand, in Comparative Examples 7, 10, and 11 in which only an aromatic compound was used as a curing agent and Comparative Examples 9 and 12 in which the content of the phosphorus compound was low, the dispersibility was poor. In addition, in Comparative Examples 7 and 9, the flame retardance was evaluated as poor. On the other hand, Comparative Example 8 in which no aromatic compound was used as a curing agent had low thermal conductivity.

### REFERENCE SIGNS LIST

10 Resin substrate

12 Resin sheet

20 Cured product

22 Resin component

30 Core material

50 Laminate substrate

1. A resin composition including a main agent containing an epoxy compound, a curing agent, and inorganic particles,
wherein the curing agent includes an aromatic compound in which a ratio of the number of carbon atoms constituting an aromatic ring to a total number of carbon atoms in one molecule is 85% or more,
a content of the inorganic particles is 40 to 75 vol % based on a total amount of components other than a solvent,
the inorganic particles include boron nitride particles and particles different from the boron nitride particles, and
a content of the boron nitride particles is 3 to 35 vol % based on a total amount of components other than a solvent.

2. The resin composition according to claim 1,
wherein the aromatic compound is a polycyclic aromatic compound having 4 to 6 benzene rings in one molecule.

3. The resin composition according to claim 1,
wherein the aromatic compound includes a triphenylbenzene compound represented by the following General Formula (1): 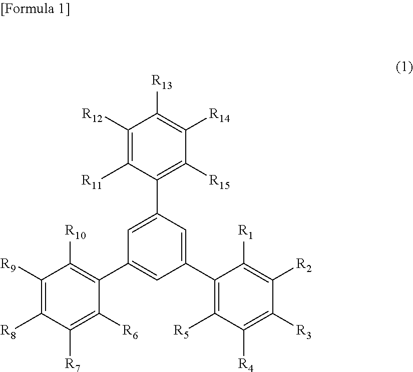
(In General Formula (1), R₁ to R₁₅ each independently represents a hydrogen atom, a hydroxyl group, an amino group or a carboxyl group, and at least one of R₁ to R₁₅ represents a hydroxyl group, an amino group or a carboxyl group.)

4. The resin composition according to claim 1,
wherein the aromatic compound includes a phosphorus compound.

5. The resin composition according to claim 1,
wherein the aromatic compound includes a phosphorus compound represented by any of the following General Formulae (2) to (4): 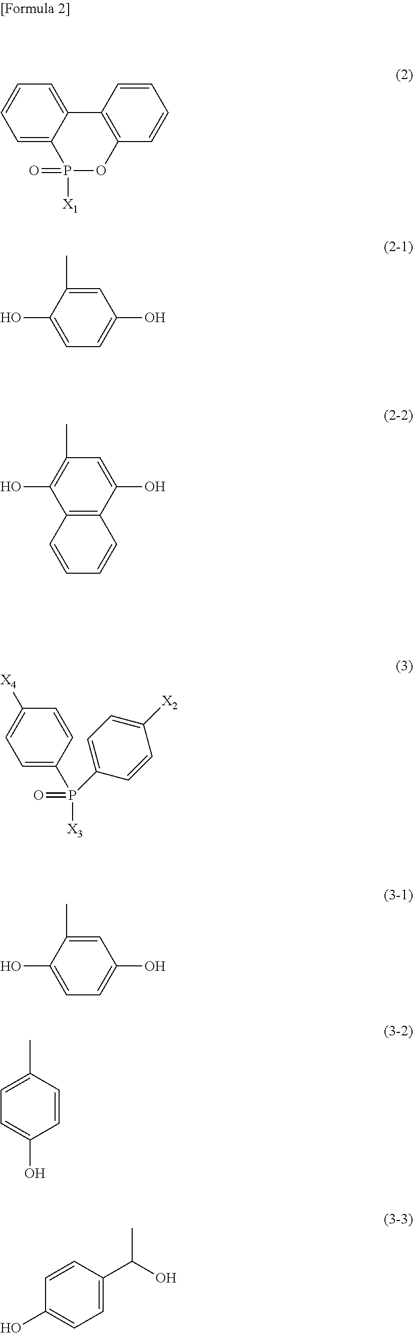 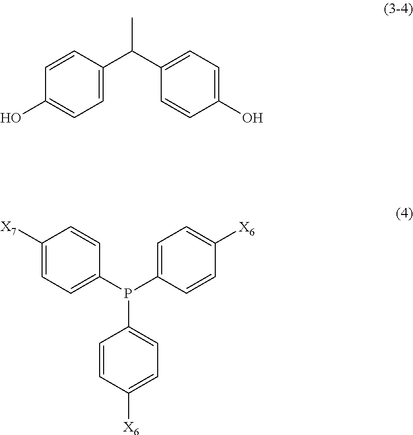
(In General Formula (2), X₁ is Formula (2-1) or (2-2)) (In General Formula (3), X₂ and X₄ each independently represents a hydrogen atom or a hydroxyl group, and X₃ represents a hydrogen atom, a hydroxyl group, a phenyl group, or any of Formulae (3-1) to (3-4)) (In General Formula (4), X₅ to X₇ each independently represents a hydrogen atom or a hydroxyl group, and at least one of X₅ to X₇ represents a hydroxyl group.)

6. A resin composition including an epoxy compound, a curing agent, and inorganic particles,
wherein the curing agent includes a phosphorus compound of at least one of the following General Formula (9) and General Formula (10); and an aromatic compound represented by the following General Formula (11), and
a content of the phosphorus compound with respect to a total of 100 parts by mass of organic components other than a solvent is 8 parts by mass or more: 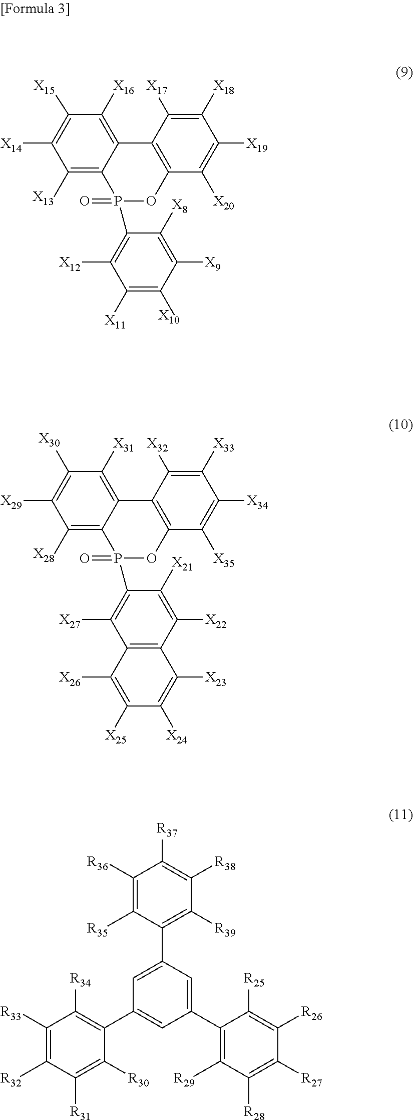
(In General Formula (9), X₈ to X₂₀ each independently represents a hydrogen atom, an alkyl group or a hydroxy group, and at least one of X₈ to X₁₂ represents a hydroxy group.)
(In General Formula (10), X₂₁ to X₃₅ each independently represents a hydrogen atom, an alkyl group or a hydroxy group, and at least one of X₂₁ to X₃₅ represents a hydroxy group.)
(In General Formula (11), R₂₅ to R₃₉ each independently represents a hydrogen atom, a hydroxyl group or an amino group, and at least one of R₂₅ to R₃₉ represents a hydroxyl group or an amino group.)

7. The resin composition according to claim 6,
wherein the content of the elemental phosphorus is 0.8 parts by mass or more with respect to a total of 100 parts by mass of the organic components.

8. The resin composition according to claim 6,
wherein the content of the phosphorus compound is 8 to 20 parts by mass with respect to a total of 100 parts by mass of the organic components.

9. The resin composition according to claim 6,
wherein the aromatic compound includes at least one of 1,3,5-tris(4-hydroxyphenyl)benzene and 1,3,5-tris(4-aminophenyl)benzene, and a total content of 1,3,5-tris(4-hydroxyphenyl)benzene and 1,3,5-tris(4-aminophenyl)benzene with respect to a total amount of the curing agent is 15 mass % or more.

10. A resin sheet obtained by molding the resin composition according to claim 1.

11. A cured resin product including a cured product of the resin composition according to claim 1.

12. A resin substrate including a cured product of the resin composition according to claim 1.

13. A laminate substrate, a plurality of resin substrates being laminated therein, wherein at least one of the plurality of resin substrates includes a cured product of the resin composition according to claim 1.

14. The resin composition according to claim 2,
wherein the aromatic compound includes a triphenylbenzene compound represented by the following General Formula (1): 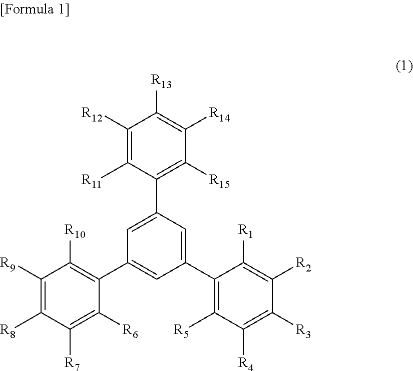
(In General Formula (1), R₁ to R₁₅ each independently represents a hydrogen atom, a hydroxyl group, an amino group or a carboxyl group, and at least one of R₁ to R₁₅ represents a hydroxyl group, an amino group or a carboxyl group.)

15. The resin composition according to claim 2,
wherein the aromatic compound includes a phosphorus compound.

16. The resin composition according to claim 3,
wherein the aromatic compound includes a phosphorus compound.

17. The resin composition according to claim 14,
wherein the aromatic compound includes a phosphorus compound.
